(19) United States
(12) Patent Application Publication
(10) Pub. No.: US 2026/0100763 A1
(43) Pub. Date: Apr. 9, 2026

(54) APPARATUS FOR QUANTUM KEY DISTRIBUTION TRANSMISSION/RECEPTION BASED ON MULTI-PROTOCOL

(71) Applicant: ELECTRONICS AND TELECOMMUNICATIONS RESEARCH INSTITUTE, Daejeon (KR)

(72) Inventors: O-Sung KWON, Daejeon (KR); Chang-Ho HONG, Daejeon (KR); Seok KIM, Daejeon (KR); Jin-Gak JANG, Daejeon (KR)

(21) Appl. No.: 18/906,317

(22) Filed: Oct. 4, 2024

(30) Foreign Application Priority Data
Mar. 22, 2024 (KR) 10-2024-0039860

(51) Int. Cl. H04B 10/61; H04B 10/70

(52) U.S. Cl. CPC H04B 10/614; H04B 10/70

(57) ABSTRACT

Disclosed herein are an apparatus for multi-protocol-based Quantum Key Distribution (QKD) transmission and an apparatus for multi-protocol-based QKD reception. The apparatus for QKD transmission may include a light source for generating an optical signal and an encoder for performing polarization or phase encoding of the optical signal according to a protocol, and the apparatus for QKD reception may include a decoder for performing decoding by controlling polarization of a received optical pulse according to a protocol and a measuring device for detecting the polarization or phase of the optical pulse.

### CROSS REFERENCE TO RELATED APPLICATION

This application claims the benefit of Korean Patent Application No. 10-2024-0039860, filed March 22, 2024, which is hereby incorporated by reference in its entirety into this application.

### BACKGROUND OF THE INVENTION

1. Technical Field

The disclosed embodiment relates to quantum key distribution technology for enabling implementation of various quantum protocols.

2. Description of Related Art

Quantum Key Distribution (QKD) technology is technology for distributing a secret key that guarantees unconditional security based on quantum mechanical principles (uncertainty and no-cloning principle). By utilizing this quantum key distribution technology, critical information can be transmitted and shared securely.

Generally, the QKD technology employs a one-to-one communication structure between a transmitter and a receiver.

As the most representative quantum protocol, there is the BB84 protocol proposed by Charles Bennett and Gilles Brassard in 1984.

In the BB84 protocol, four polarization states (vertical (90˚), horizontal (0˚), and ±45˚) forming two bases are used to encode information into single photons. Alice (a sender) randomly selects a basis state, randomly selects one of the two polarization states of the selected basis, encodes the same into a photon, and sends the photon to Bob (a receiver). Upon receiving the photon, Bob measures/records the polarization state using a random basis state. When communication between the two users is completed, Alice and Bob disclose their bases and generate a secret key from the polarization states of the photons in which their bases match each other.

However, even QKD technology known as the most secure one cannot guarantee security due to imperfect implementation. In order to overcome this, various protocols and optical signal transmission technologies have been developed.

The conventional QKD implementation technologies implement QKD systems optimized for implementation of protocols in order to enhance security of the protocols. In other words, only one protocol can be implemented in a single QKD system. Therefore, depending on various environments and situations, it is necessary to develop QKD protocols suitable therefor.

This leads to reduced compatibility among QKD devices and economic loss and slows the commercialization of QKD technology.

### [DOCUMENTS OF RELATED ART]

(Patent Document 1) Korean Patent No. 10-1262688, registered on May 3, 2013 and titled “Quantum key distribution system”

(Patent Document 2) Korean Patent No. 10-2134347, registered on July 9, 2020 and titled “Method for quantum key distribution”

(Patent Document 3) Korean Patent Application Publication No. 10-2022-0060469, published on May 11, 2022 and titled “Quantum key distribution system and operation method thereof”.

### SUMMARY OF THE INVENTION

An object of the disclosed embodiment is to enable various protocols to be implemented in a single QKD system.

An apparatus for quantum key distribution (QKD) transmission according to an embodiment may include a light source for generating an optical signal and an encoder for performing polarization or phase encoding of the optical signal according to a protocol.

Here, the encoder may include a circulator for outputting the optical signal to a phase modulator and outputting an optical signal output from the phase modulator to the outside, the phase modulator for performing polarization or phase encoding of the optical signal output from the circulator according to the protocol and outputting an optical signal reflected from a Faraday mirror to the circulator, and the Faraday mirror for reflecting the optical signal passing through the phase modulator.

Here, the light source may inject an optical signal with a polarization state of 45 degrees into the encoder, a + operating voltage may be applied when the optical signal passes through the phase modulator, and a – operating voltage may be applied when the optical signal reflected from the Faraday mirror passes through the phase modulator.

Here, the light source may inject an optical signal with a polarization state of 45 degrees into the encoder, and a + or – operating voltage may be applied when the optical signal passes through the phase modulator.

An apparatus for Quantum Key Distribution (QKD) reception according to an embodiment may include a decoder for performing decoding by controlling polarization of a received optical pulse according to a protocol and a measuring device for detecting the polarization or phase state of the optical pulse.

Here, the decoder may include a beam splitter for splitting optical signals transmitted from two or more transmission apparatuses, a first polarization controller for controlling polarization of a split first beam according to the protocol, a first polarization beam splitter for splitting a signal output from the first polarization controller, a second polarization controller for controlling polarization of a split second beam according to the protocol, and a second polarization beam splitter for splitting a signal output from the second polarization controller.

Here, the measuring device may include first and second photodetectors for detecting the polarization or phases of respective output signals split in the first polarization beam splitter and third and fourth photodetectors for detecting the polarization or phases of respective output signals split in the second polarization beam splitter.

Here, the first to fourth photodetectors may transmit results of measuring the arrived signals to an electronic control board depending on a detector driving signal generated in the electronic control board and the electronic control board analyzes the results.

Here, the first to fourth photodetectors may perform Bell state measurement.

Here, the electronic control board may drive the first to fourth photodetectors using the driving signal at the same speed as the optical signal.

Here, the electronic control board may arrange only results satisfying the Bell state measurement and transmit the results to the transmission apparatuses.

Here, the first polarization controller may be set to 0 degrees, and the second polarization controller may be set to 45 degrees.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic configuration diagram of a Quantum Key Distribution (QKD) system;

FIG. 2 is a schematic configuration diagram of a multi-protocol-based Quantum Key Distribution (QKD) system according to an embodiment;

FIG. 3 is an internal configuration diagram of an encoder of an apparatus for multi-protocol-based Quantum Key Distribution (QKD) transmission according to an embodiment;

FIG. 4 is an internal configuration diagram of a decoder of an apparatus for multi-protocol-based Quantum Key Distribution (QKD) reception according to an embodiment; and

FIG. 5 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

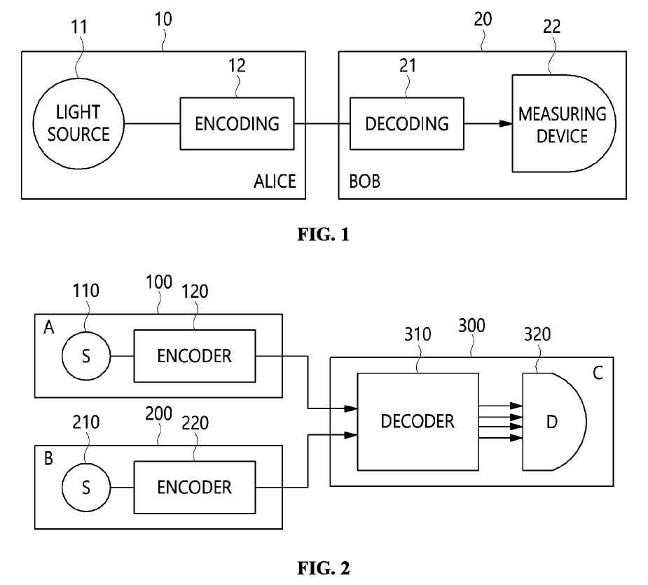

FIG. 1 is a schematic configuration diagram of a Quantum Key Distribution (QKD) system.

Referring to FIG. 1, the Quantum Key Distribution (QKD) system includes a sender (Alice) 10 and a receiver (Bob) 20.

In the QKD system, the sender (Alice) 10 and the receiver (Bob) 20 may securely share a secret key.

Specifically, the sender (ALICE) 10 generates an optical pulse at a single photon level in a light source 11, encodes information for generating a secret key into the optical pulse 12, and transmits the optical pulse to the receiver (Bob) 20.

The receiver (Bob) 20 decodes (21) the optical pulse received from the sender (Alice) 10 and measures the state of the optical pulse through a measuring device 22.

Accordingly, the information transmitted by the sender (Alice) 10 is compared with the result measured by the receiver (Bob) 20, whereby the secret key may be shared.

However, the quantum key distribution system such as that illustrated in FIG. 1 basically employs one-to-one communication. Therefore, it is not easy to implement various protocols in a single apparatus due to security and generation efficiency.

Accordingly, an embodiment intends to implement various protocols in a single quantum key distribution (QKD) system.

FIG. 2 is a schematic configuration diagram of a multi-protocol-based Quantum Key Distribution (QKD) system according to an embodiment.

Referring to FIG. 2, the multi-protocol-based Quantum Key Distribution (QKD) system according to an embodiment may be configured with two or more transmission apparatuses (Alice (A) and Bob (B)) 100 and 200 and a single reception apparatus (Charlie (C)) 300.

Here, communication between the sender A and the sender B, between the sender A and the receiver C, or between the sender B and the receiver C is possible according to a protocol. That is, the protocol may be determined depending on the target of quantum key distribution.

To this end, according to an embodiment, each of the two or more senders (Alice and Bob) 100 and 200 encodes information for generating a secret key into an optical signal and transmits the optical signal according to the protocol.

That is, the two or more senders (Alice and Bob) 100 and 200 may include respective light sources 110 and 210 for generating optical signals and respective encoders 120 and 220 for polarization or phase encoding of the optical signals according to the protocol.

Also, according to an embodiment, the single receiver (Charlie) 300 performs decoding according to the respective protocols and notifies the senders (Alice and Bob) 100 and 200 of measurement results. Then, the senders (Alice and Bob) 100 and 200 generate secret keys using the results.

That is, the reception apparatus (Charlie (C)) 300 may include a decoder for performing decoding by controlling the received optical pulse according to a protocol and a measuring device 320 for detecting the polarization or phase state of the optical pulse.

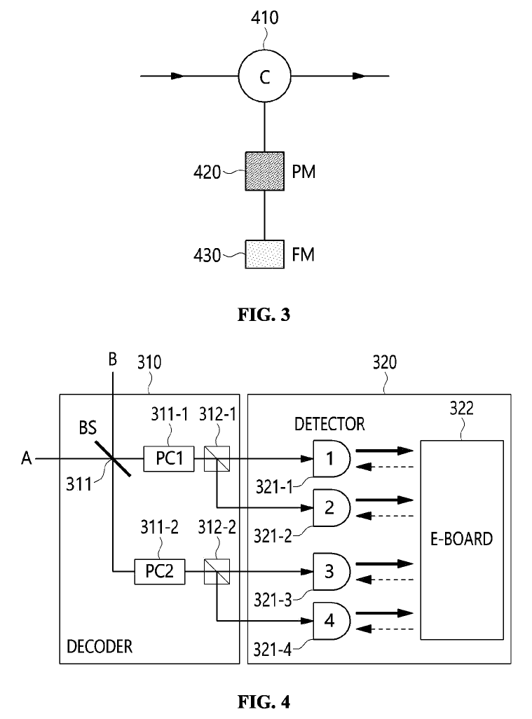

FIG. 3 is an internal configuration diagram of an encoder of an apparatus for multi-protocol-based Quantum Key Distribution (QKD) transmission according to an embodiment.

Referring to FIG. 3, the encoder 120 or 220 of the apparatus for multi-protocol-based Quantum Key Distribution (QKD) transmission according to an embodiment may include a circulator (C) 410, a phase modulator (PM) 420, and a Faraday Mirror (FM) 430.

The circulator 410 may input an optical signal to the phase modulator 420, and may output the optical signal output from the phase modulator 420 to the outside.

The phase modulator 420 performs polarization or phase encoding of the optical signal output from the circulator 410 and transfers the optical signal reflected from the Faraday mirror 430 to the circulator 410.

The Faraday mirror 430 reflects the optical signal passing through the phase modulator 420.

That is, after the input optical signal passes through the circulator 410 and the phase modulator 420, the optical signal is reflected back from the Faraday mirror 430 and output to the output terminal of the circulator 410 via the phase modulator 420. Here, according to the protocol, polarization or phase encoding may be performed using the phase modulator 420.

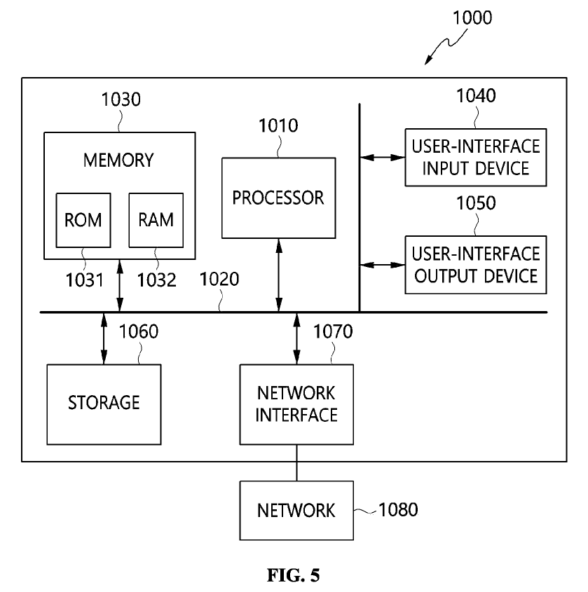

FIG. 4 is a detailed configuration diagram of the apparatus for multi-protocol-based Quantum Key Distribution (QKD) reception according to an embodiment.

Referring to FIG. 4, the decoder 310 of the apparatus for multi-protocol-based Quantum Key Distribution (QKD) reception according to an embodiment may include a beam splitter (BS) 311, polarization controllers (PCs) 311-1 and 311-2, and polarization beam splitters 312-1 and 312-2.

The beam splitter 311 may split optical signals transmitted from two or more transmission apparatuses.

The polarization controllers 311-1 and 311-2 may include the first polarization controller 311-1 and the second polarization controller 311-2 that respectively process the two optical signals split by the beam splitter 311.

Here, the first polarization controller 311-1 and the second polarization controller 311-2 may measure the states of the respective optical signals, which are split and input thereto, according to the protocol.

The polarization beam splitters 312-1 and 312-2 may include the first polarization beam splitter 312-1 and the second polarization beam splitter 312-2 that respectively split the two optical signals respectively output from the first polarization controller 311-1 and the second polarization controller 311-2.

Accordingly, the detector 320 of the apparatus for multi-protocol-based Quantum Key Distribution (QKD) reception according to an embodiment is configured with multiple detectors 321-1, 321-2, 321-3, and 321-4, thereby identifying the polarization or phase state of the signal received from the decoder 310.

The multiple detectors 321-1, 321-2, 321-3, and 321-4 may include the first detector 321-1 and the second detector 321-2 for detecting the polarization or phase states of the respective output signals split in the first polarization beam splitter 312-1 and the third detector 321-3 and the fourth detector 321-4 for detecting the polarization or phase states of the respective output signals split in the second polarization beam splitter 312-2.

That is, the optical signals transmitted from the two transmission apparatuses 100 and 200 are measured using the four photodetectors 321-1, 321-2, 321-3, and 321-4 after interference by the beam splitter 311.

Here, when a detector driving signal (the dotted line in the drawing) generated in an electronic control board (E-board) 322 is present, the photodetectors 321-1, 321-2, 321-3, and 321-4 transmit the results of measuring the arrived optical signal to the electronic control board 322 (the solid lines in the drawing). Accordingly, the electronic control board 322 analyzes the results of the measurements of the optical signal.

Hereinafter, embodiments for implementing the multi-protocol-based Quantum Key Distribution (QKD) system according to the above-described embodiment based on various quantum protocols will be described.

### FIRST EMBODIMENT

According to the first embodiment, a polarization-based Measurement-Device-Independent Quantum Key Distribution (MDI-QKD) protocol may be implemented in the multi-protocol-based Quantum Key Distribution (QKD) system.

The transmission apparatuses (Alice (A) and Bob (B)) 100 and 200 illustrated in FIG. 2 inject optical signals with a polarization state of 45 degrees into the respective encoders 120 and 220.

Here, when the optical signal passing through the circulator 410 illustrated in FIG. 3 passes through the phase modulator 420, a + operating voltage is applied, and when the optical signal is returned from the Faraday mirror 430, a - operating voltage is applied. As a result, the polarization state of the optical signal is determined at the output terminal of the circulator 410 by the difference between the two operating voltages.

Here, any of four polarization states may be randomly generated using the voltage difference.

The two transmission apparatuses (Alice (A) and Bob (B)) 100 and 200 transmit the encoded optical signals to the reception apparatus (Charlie (C)) 300.

For the optical signals arriving at the reception apparatus (Charlie (C)) 300, Bell state measurement is performed using the four photodetectors 321-1, 321-2, 321-3, and 321-4 after interference by the beam splitter 311 illustrated in FIG. 4.

Here, the driving signal generated in the electronic control board 322 is generated at the same speed as the optical signal, and it equally drives the four photodetectors 321-1, 321-2, 321-3, and 321-4 for coincidence counting.

Here, the polarization controllers 311-1 and 311-2 maintain the state of 0. Only results satisfying the Bell state measurement, among the measured results, are arranged in the electronic control board 322 and transferred to the two transmission apparatuses (Alice (A) and Bob (B)) 100 and 200, and the two transmission apparatuses (Alice (A) and Bob (B)) 100 and 200 may generate secret keys based thereon.

### SECOND EMBODIMENT

According to the second embodiment, a one-way BB84 protocol may be implemented in the multi-protocol-based Quantum Key Distribution (QKD) system. Because it basically employs one-to-one communication, communication is performed between a single sender and a single receiver (Alice and Charlie or Bob and Charlie).

One of the senders (Alice and Bob) 100 and 200 illustrated in FIG. 2 performs encoding of an optical signal through the encoder 120 or 220 and transmits the encoded optical signal to the receiver (Charlie) 300.

The receiver (Charlie) 300 randomly selects a basis and measures the state of the optical signal in order to measure the characteristics of the received optical signal.

First, in order to select the basis, the first polarization controller 311-1 and the second polarization controller 311-2 illustrated in FIG. 4 are set to 0 degrees and 45 degrees, respectively.

Here, the electronic control board 322 operates the photodetectors 321-1, 321-2, 321-3, and 321-4 at a random speed through a photodetector driving signal.

That is, selecting the basis of the first polarization controller 311-1 indicates that only the detector 1 (321-1) and the detector 2 (321-2) are used for the measurement, and no operating voltage is generated in the detector 3 (321-3) and the detector 4 (321-4).

Conversely, selecting the basis of the second polarization controller 311-2 indicates that only the detector 3 (321-3) and the detector 4 (321-4) are used for the measurement, and no operating voltage is generated in the detector 1 (321-1) and the detector 2 (321-2).

Through the result measured by the detector 1 (321-1) and the detector 2 (321-2) or the result measured by the detector 3 (321-3) and the detector 4 (321-4) as described above, the sender (Alice or Bob) 100 or 200 may generate a secret key.

### THIRD EMBODIMENT

According to the third embodiment, a Twin Field (TF) QKD protocol may be implemented in the multi-protocol-based Quantum Key Distribution (QKD) system.

Unlike in the first embodiment, the transmission apparatuses (Alice (A) and Bob (B)) 100 and 200 illustrated in FIG. 2 apply an operating voltage to the phase modulator only once, not twice.

Another advantage is that, because the transmission apparatuses (Alice (A) and Bob (B)) 100 and 200 maintain the same state when initial settings are made, they may have the same phase shift value.

Accordingly, the transmission apparatuses (Alice (A) and Bob (B)) 100 and 200 perform phase modulation encoding and transmit the result thereof to the reception apparatus (Chalie (C)) 300. Accordingly, after interference in the beam splitter 311 of the reception apparatus 300, coincidence counting is performed in the detector 1 (321-1) and the detector 3 (321-3) or in the detector 2 (321-2) and the detector 4 (321-4).

Through the result measured by the detectors, generation of a secret key may be performed.

FIG. 5 is a view illustrating a computer system configuration according to an embodiment.

The transmission apparatuses 100 and 200 and the reception apparatus 300 of the multi-protocol-based Quantum Key Distribution (QKD) system according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, various quantum protocols may be implemented using a single QKD apparatus.

This describes that a protocol can be easily changed without changing a system even though a communication environment is changed. Therefore, it is economically efficient because no additional cost is incurred. Also, even though an error occurs in the system due to a change in the external environment, a minimal QKD system may be driven by changing the protocol.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for quantum key distribution (QKD) transmission, comprising:
a light source for generating an optical signal; and
an encoder for performing polarization or phase encoding of the optical signal according to a protocol.

2. The apparatus of claim 1, wherein the encoder includes:
a circulator for outputting an optical signal to a phase modulator and outputting an optical signal output from the phase modulator to an outside;
the phase modulator for performing polarization or phase encoding of the optical signal output from the circulator according to the protocol and outputting an optical signal reflected from a Faraday mirror to the circulator; and
the Faraday mirror for reflecting the optical signal passing through the phase modulator.

3. The apparatus of claim 2, wherein:
the light source injects an optical signal with a polarization state of 45 degrees into the encoder,
a + operating voltage is applied when the optical signal passes through the phase modulator, and
a – operating voltage is applied when the optical signal is reflected from the Faraday mirror.

4. The apparatus of claim 2, wherein:
the light source injects an optical signal with a polarization state of 45 degrees into the encoder, and
a + or – operating voltage is applied when the optical signal passes through the phase modulator.

5. An apparatus for Quantum Key Distribution (QKD) reception, comprising:
a decoder for performing decoding by controlling polarization of a received optical pulse according to a protocol; and
a measuring device for detecting polarization or a phase of the optical pulse.

6. The apparatus of claim 5, wherein the decoder includes:
a beam splitter for splitting optical signals transmitted from two or more transmission apparatuses;
a first polarization controller for controlling polarization of a split first beam according to the protocol;
a first polarization beam splitter for splitting a signal output from the first polarization controller;
a second polarization controller for controlling polarization of a split second beam according to the protocol; and
a second polarization beam splitter for splitting a signal output from the second polarization controller.

7. The apparatus of claim 6, wherein the measuring device includes:
first and second photodetectors for detecting polarization or phases of respective output signals split in the first polarization beam splitter; and
third and fourth photodetectors for detecting polarization or phases of respective output signals split in the second polarization beam splitter.

8. The apparatus of claim 7, wherein the first to fourth photodetectors transmit results of measuring arrived optical signals to an electronic control board according to a detector driving signal generated in the electronic control board, and
the electronic control board analyzes the results.

9. The apparatus of claim 8, wherein the first to fourth photodetectors perform Bell state measurement.

10. The apparatus of claim 9, wherein the electronic control board drives the first to fourth photodetectors using the driving signal at a same speed as the optical signal.

11. The apparatus of claim 9, wherein the electronic control board arranges only results satisfying the Bell state measurement and transmits the results to the transmission apparatuses.

12. The apparatus of claim 9, wherein:
the first polarization controller is set to 0 degrees, and
the second polarization controller is set to 45 degrees.
